(19) United States
(12) Patent Application Publication
(10) Pub. No.: US 2023/0132444 A1
(43) Pub. Date: May 4, 2023

(54) BEVERAGE PREPARATION DEVICE

(71) Applicant: SOCIETE DES PRODUITS NESTLE S.A., Vevey (CH)

(72) Inventors: ALEXANDRE PUGLIESE, Paudex (CH); ALEXANDRE PERENTES, Sullens (CH)

(21) Appl. No.: 17/906,654

(22) PCT Filed: Mar. 29, 2021
(86) PCT No.: PCT/EP2021/058090

§ 371 Date: Sep. 19, 2022

(30) Foreign Application Priority Data
Mar. 30, 2020 (EP) 20166603.9

(51) Int. Cl. B67D 1/00; B67D 1/08

(52) U.S. Cl. CPC B67D 1/0016; B67D 1/0895; B67D 1/0859; B67D 1/0054; B67D 2210/0001; B67D 2210/00015

(57) ABSTRACT

The invention relates to a method for preparing a beverage and to a beverage preparation device (1), such as a beverage dispenser, for simpler and more efficient sanitization of water. The beverage preparation device (1) comprises: a buffer tank (2) having a tank body for storing an amount of water, a recirculation line (20) configured to allow water circulating out of and back into the buffer tank (2) to form a recirculation path together with the buffer tank (2), a UV lamp (40) arranged for irradiating UV light at a position along the recirculation path to sanitize the water, a cooling unit (3) for cooling the water within the buffer tank (2), a discharge line (23) for discharging the water from the buffer tank (2) via a discharge outlet (24), and a pump (26) for selectively circulating water along the recirculation path or the discharge line (23) towards the discharge outlet.

### FIELD OF THE INVENTION

The present invention relates to a beverage preparation device and a method for preparing a beverage.

### TECHNICAL BACKGROUND

A beverage preparation device may be used for on demand beverage dispensing. Such beverage preparation devices are convenient, since the user of the device can on demand request a beverage and subsequently directly consume the beverage.

As a main ingredient, water may be used for the preparation of the beverage. In the beverage preparation device, the water comes into contact with several device parts, such as a pump and tubes, which are required for preparing or at least dispensing the beverage. Water may be a breeding ground for pathogens (also called “germs”), i.e. an infectious microorganism or agent, such as a virus, bacterium, or fungus. In general, germs may produce a disease. The beverage preparation device thus needs to be cleaned regularly in order to prevent or at least substantially reduce the germ formation.

Cleaning of the beverage preparation device is, however, time-consuming and cumbersome, since the respective parts of the device are difficult to be accessed and since cleaning needs to be carried out regularly. Hence, even if measures are taken for cleaning the beverage preparation, there is still the risk that germs are formed in the device and that a consumer of the beverage preparation device consumes contaminated water having germs.

Furthermore, there may be the risk that the beverage preparation machine uses water, which already includes germ. This may happen, when the respective water network does not provide germ-free or sanitized water. Therefore, without any proper means for sanitizing the water, there is a severe risk that the consumer consumes water that contains germs.

Therefore, it is an object of the present invention to provide a beverage preparation device and method for preparing a beverage, which overcome the afore-mentioned drawbacks. That is, it is in particular an object of the present invention to provide sanitized (germ-free) water more easily, in particular irrespective of place, time and the available technical means.

These and other objects, which become apparent upon reading the following description, are solved by the subject matter of the independent claims. The dependent claims refer to preferred embodiments of the invention.

### SUMMARY OF THE INVENTION

According to the invention, a beverage preparation device is provided. The beverage preparation device comprises: a buffer tank having a tank body for storing an amount of water, a recirculation line configured to allow water circulating out of and back into the buffer tank to form a recirculation path together with the buffer tank, a UV lamp arranged for irradiating UV light at a position along the recirculation path to sanitize the water, a cooling unit for cooling the water within the buffer tank, a discharge line for discharging the water from the buffer tank via a discharge outlet, and a pump for selectively circulating water along the recirculation path or the discharge line towards the discharge outlet.

The beverage preparation device thus facilitates that no access to the beverage preparation device is required to inactivate (deactivate) or destroy the pathogens (in the following also referred to as “germs”, such as viruses, bacteria, fungi, etc.) in the water. Therefore, the water is easily sanitized and, thus, purified, and the risk of the discharged water containing germs is eliminated or at least substantially reduced. For example, the beverage preparation device may have a sanitization mode and a discharging mode, wherein in the sanitization mode, the water circulates along the circulation line and is sanitized by the UV light of the UV lamp, and wherein in the dispensing mode, the so sanitized water is discharged via the discharge outlet. As such, the beverage preparation device may include only the sanitization mode and the dispensing mode in order to sanitize and, thus, purify the water. Further, the beverage preparation device may be used with water irrespective of the water quality (e.g. also germ-containing water), since the beverage preparation device provides an integral sanitization of the water, which is subsequently, i.e. when sanitization has been finished, dispensed via the discharge outlet.

It should also be noted that such beverage preparation device may also be used for purifying a reversed osmosis water in which all protective chemicals like chlorine have been removed. In such type of water, micro-organism can grow so that it needs to be purified and kept in optimal sanitized environment.

The cooling unit may be arranged and configured to freeze an amount of water at an inner wall of the tank body, wherein the cooling unit preferably at least partially surrounds the tank body. Thereby, cooling of the water, which is to be discharged via the discharge outlet, is accelerated.

The beverage preparation device may further comprise a water supply being connected with the buffer tank by a supply line for supplying water into the buffer tank. The water supply is a primary water tank. Thus, the water supply may be adapted to contain an amount of water that is greater than the amount, which the buffer tank (i.e. a secondary water tank) can contain. The water supply is detachably or integrally provided with the beverage preparation device. Therefore, a user of the device can easily remove the water supply from the device, for example in order to install a new water supply and/or in order to clean the water supply.

Additionally or alternatively, the beverage preparation device may comprise a water connection. The water connection may be connected with the buffer tank by a supply line, e.g. by the before-mentioned supply line or an additional supply line. The water connection may be configured to be connectable to a water outlet, such as of a (drinking) water network.

The supply line may comprise a water filter for filtering water passing through the supply line from the water supply to the buffer tank, wherein the water filter comprises at least one of the group consisting of a particle filter, an ultrafiltration device, a nano-filtration device, an active carbon device, and a reverse osmosis device. The water filter may thus prevent that germs and/or particles promoting the formation of germs are prevented from being supplied to the buffer tank and the discharge outlet. The filter may filter particles down to 0.001 microns Thereby, the water purification by the device can be accelerated.

The UV lamp may be arranged to irradiate UV light into the recirculation line and/or into the buffer tank. As such, a very effective sanitization of the water is achieved.

The beverage preparation device may further comprise a beverage additive section for dispensing additives, such as in the form of a liquid or in the form of a liquid comprising solid particles, via the discharge outlet. The additives may thus in combination with the water discharged via the discharge outlet form a final product, which has, dependent on the additives, a specific taste and/or function.

The beverage additive section is preferably arranged in a secondary discharge line connecting the buffer tank or the recirculation line with the discharge outlet to feed the beverage additive section with the water from the buffer tank.

The additives may comprise at least one of the group consisting of: flavors, aromas (for example orange, peach, lemon, etc.), minerals (for example magnesium, calcium, potassium, etc.), a mineral liquid concentrate, a functional concentrate (such as an additive comprising a vitamin, caffeine or another coffee extract; “functional concentrate” is to be understood as having an effect on the consumer, such as a product that is probiotic, prophylactic, stimulatory, etc.), an edible flavoring concentrate, a tea and/or coffee extract, a fruit juice, a minerals mother solution or combinations thereof.

The beverage additive section is preferably adapted to dispense the additives to the water from the buffer tank such that the additives designate an amount up to 20%, preferably 10%, preferably 5%, preferably 0.05% to 1%, preferably 0.1% to 0.5% by volume, of the resulting liquid material in the final product.

The beverage preparation device may further comprise a flow direction (or flow redirection or flow separation) device for controlling the flow of water circulating selectively along the recirculation path or the discharge line towards the discharge outlet. The flow direction device may prevent that, when water circulates along the recirculation path, water is circulating along the discharge line. As such, it can be prevented that not yet sanitized water circulates along the discharge line and towards the discharge outlet. The flow direction device may prevent that, when water circulates along the discharge line, no water is circulating along the recirculation path. As such, the energy provided by the pump can be effectively used for discharging the water via the discharge outlet.

The flow direction device may comprise a branching section in the recirculation line for branching off the discharge line, wherein the discharge line extends to a higher level than the recirculation line so that water pumped by the pump at a flow rate below a defined threshold value drains via the recirculation line back into the buffer tank, and water pumped by the pump at a flow rate at or above the defined threshold value flows via the discharge line towards and out of the discharge outlet. As such, the branching section may facilitate that only the pump is used for selectively circulating the water along the recirculation path or the discharge line and towards the discharge outlet. This effects that a very simple flow direction device is provided. This in particular for the reason that the flow direction device thus forms a passive arrangement, which does not need to be actively controlled.

Additionally, or alternatively, the flow direction device may comprise a two-way valve or a three-way valve. Having only a valve as the flow direction device may effect that the pump can be operated with a single flow rate, both for circulating the water along the recirculation path and along the discharge line. Thereby, the control of the pump can be simplified.

The recirculation path may comprises a second filter to sanitize the water on the inlet line or on the delivery line to eliminated any particles (such as germs or other particles facilitating the formation of germs) from moving into the recirculation line 20 of the loop sanitizer. In any case the filter is positioned before the UV lamp 40 to apply the filtering before the sanitization of the water.

The beverage preparation device may further comprise an in-line carbonation device for entering CO2 (carbon dioxide) into the circulating water, preferably in the discharge line or flow direction device. Hence, the beverage preparation device may discharge a beverage with carbonated water (soda water, sparkling water, seltzer, or seltzer water, etc.) containing dissolved carbon dioxide gas.

The beverage preparation device may comprise an insulation housing encapsulating the buffer tank, the cooling unit, the UV lamp and the recirculation line, and preferably also the pump, the flow direction device, the supply line, and the water filter. The insulation housing in particular effects that heat cannot easily be transferred to the inside of the housing, thereby easily maintaining the cooling by the cooling unit.

The beverage preparation device may further comprise a heating unit arranged to transfer heat to the buffer tank in order to sanitize the water within the buffer tank. The heating unit may be adapted to heat the water to a temperature in a range from 70° C. to 100° C. For example, in an idle (or off) mode or idle (or off) state of the beverage preparation machine (e.g. in a state in which one or more of the UV lamp, cooling unit, and pump is deactivated), the heating unit may be activated in order to transfer the heat to the buffer tank. The heating unit facilitates that even more germs are inactivated or destroyed in the water, which is to be discharged via the discharge outlet. In particular, the heating unit prevents that germs settle or develop in the buffer tank. In other words, the heating unit may effect that the full fluid or liquid line, which extends along the recirculation path, is sanitized (disinfected). The beverage preparation device may be adapted to activate the heating unit periodically. The heating unit may be adapted to melt the frozen amount of water at the inner wall of the body of the buffer tank.

According to a further aspect of the invention, a method for preparing a beverage is provided. The method comprises the steps of: filling water into a buffer tank, circulating the water along a recirculation path extending from the buffer tank via a recirculation line and back to the buffer tank, cooling the water in the buffer tank by a cooling unit, sanitizing the cooled and recirculating water by UV light irradiated by a UV lamp arranged at a position along the recirculation path, after the water has been sanitized, discharging the sanitized water via a discharge line and discharge outlet.

Additionally, the recirculation line may comprise a filter at a position along the recirculation path and positioned prior to the UV lamp on the recirculation line.

The above-mentioned advantages and description with respect to the device apply analogously to the method.

The buffer tank may be automatically supplied with water via a supply line. For example, the automatic supply with water may be carried out based on one or more measured liquid levels of the buffer tank. The buffer tank may comprise a measuring or sensor unit (level sensors, etc.) for measuring/sensing a level of liquid or water in the buffer tank, wherein when the (actual) level is below a predetermined level, the buffer tank is automatically supplied with water. In addition, the buffer tank may also comprise an ice detection sensor based on conductivity change, aiming at stopping the compressor when the required thickness of ice is created on the walls (typically 1 cm). Additionally or alternatively, the buffer tank may be supplied with water via a (e.g. additional) supply line or the supply line on demand. On demand supplying may be carried out by a user input (e.g., an input on a button or any other user interface). Preferably, the water passing through the supply line is filtered by a water filter in the supply line.

The cooling unit may freeze part of the water in the buffer tank at the inner wall of its tank body. Advantageously, the presence of ice on the inner walls of the buffer tank will allow to speed up the cooling time the next water batch preparation.

A branch section may be provided in the recirculation line for branching off the discharge line, and the water circulating at a flow rate below a defined threshold value drains via the recirculation line back into the buffer tank, and water circulating at a flow rate at or above the defined threshold value flows via the discharge line towards and out of the discharge outlet.

The water to be discharged via the discharge line and discharge outlet may be carbonized by in-line carbonation.

### BRIEF DESCRIPTION OF DRAWINGS

In the following, the invention is described exemplarily with reference to the enclosed figures, in which:

FIG. 1 shows a schematic view of a beverage preparation device according to a preferred embodiment of the invention;

FIG. 2 shows an optional flow redirection device of the embodiment according to FIG. 1.

### DETAILED DESCRIPTION

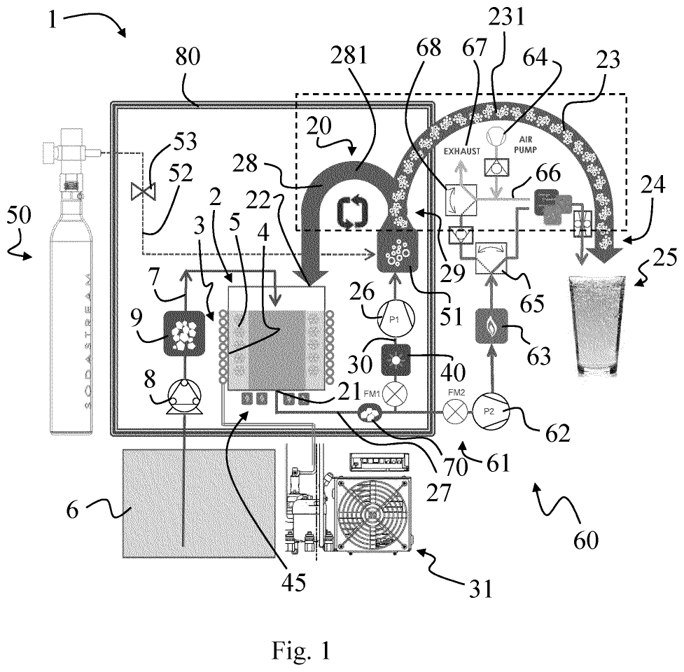

FIG. 1 exemplarily shows a beverage preparation device 1 or water system according to a preferred embodiment of the invention. The beverage preparation device 1 may be adapted for being used by a consumer, who requests (on demand) a beverage from the beverage preparation device 1. That is, the beverage preparation device 1 may be adapted to discharge a beverage that is ready for drinking by the consumer, i.e. a ready-to-drink beverage. The beverage preparation device 1 is not limited to a specific design. Preferably, the beverage preparation device 1 is designed to be used on the side of a business (B2B) and/or on the side of a customer (B2C). For example, the beverage preparation device 1 may be designed as a vending machine (airport, mall, public area, etc.), in B2B (hotel, restaurant, café, i.e. “HoReCa”, fitness center, office, etc.) and/or B2C (e.g., at home). The beverage preparation device 1 may be designed as a vending machine, a water dispenser, and/or a home appliance device. The beverage preparation device 1 may be designed for being mounted or positioned to a wall (wall-mounted), a bottom, and/or a tabletop, and/or the beverage preparation device 1 may have a freestanding design. The beverage preparation device 1 may comprise a connection for a power supply in order to supply the respective components of the beverage preparation device 1 with electrical energy.

The beverage preparation device 1 comprises a buffer tank 2 having a tank body for storing an amount of water. The tank body comprises a bottom and a wall extending from the bottom and surrounding the amount of water stored in the tank body. The buffer tank 2 is not restricted to a specific design and/or volume. For example, the volume of the buffer tank 2, i.e. the maximum amount the buffer tank 2 can store in the tank body, is between 1 I and 3 I, preferably between 1.5 I and 2.5 I, and most preferably 1.9 I. The beverage preparation device 1 also comprises a cooling unit 3 for cooling the water within the buffer tank 2. The cooling unit 3 is not limited to a specific arrangement with respect to the buffer tank 2 as long as heat can be transferred away from the buffer tank 2 in order to cool the water within the buffer tank 2. In a preferred example, the cooling unit 3 at least partially surrounds the tank body of the buffer tank 2. The cooling unit 2 may cool the amount of water within the buffer tank 2 such that the water in at least the buffer tank 2 has a specific temperature. For example, the cooling unit 2 may be adapted to effect a temperature of the water within the buffer tank 2 of at most 4° C. and preferably not below 0° C. The cooling unit 3 may be arranged and configured to freeze an amount of water at an inner wall 4 of the tank body 2. The inner wall 4 may be the sidewall of the tank body 2 and/or the inner side of the sidewall of tank body 2. By freezing an amount of water at the inner wall 4 by the cooling unit 3, an ice layer 5 is formed. The ice layer 5 at least partially and preferably circumferentially surrounds the water within the buffer tank 2, which is not frozen. The ice on the walls allows speeding up the cooling time for the next batch preparation.

The cooling unit 3 may comprise a compressor unit 31. The cooling unit 3 may comprise a circulating liquid refrigerant as the medium, which absorbs and removes the heat from the buffer tank and, thus, from the water therein, such that the water is cooled. The compressor unit 31 is thus adapted to compress the refrigerant so that the refrigerant undergoes the phase changes for cooling. The compressor unit 31 may be at least in part provided on an outside of the beverage preparation device 1, e.g. on an outer wall of the housing of the beverage preparation device 1, so that the heat removed from the buffer tank 2 can be effectively transferred away from the beverage preparation device 1 and/or the housing.

The beverage preparation device 1 further comprises a water supply 6 being connected with the buffer tank 2 by a supply line 7 for supplying water into the buffer tank 2. The water supply 6 may be a primary water tank, so that the buffer tank 2 is a secondary water tank. The water tank 6 is preferably designed to store a greater amount of water than the buffer tank 2. For example, the amount of water, which the water supply 6 can store, is at least twice the amount of water, which the buffer tank 2 can store. In an embodiment, the water supply 6 can store between 2.5 and 5 I of water, preferably between 3 and 4.5 I, most preferably 3.8 I.

The water supply 6 may be detachably provided with respect to the beverage preparation device 1. For example, a user of the beverage preparation device 1 may detach the (e.g. empty) water supply 6 in order to subsequently attach a new (e.g., full) water supply 6 to or in the beverage preparation device 1. Additionally or alternatively, the water supply 6 may comprise a port, wherein via this port water can be filled into the water supply 6, and/or wherein this port is adapted to connect with a water network, such as with an outlet for mains water (tap water). The water supply 6 may also be integrally provided with the beverage preparation device 1. For example, the water supply 6 may comprise a part of the housing of the beverage preparation device 1 and/or may be permanently (e.g. by way of a material connection such as welding) connected to the beverage preparation device 1.

Supplying the water from the water supply 6 via the supply line 7 to the buffer tank 2 can be carried out in many different ways. For example, the beverage preparation device 1 comprises an arrangement adapted to (selectively) move (defined) amounts of water from the water supply 6 to the buffer tank 2. As shown in FIG. 1, the beverage preparation device 1 may comprise, for example, a pump 8 (i.e. a refilling pump), wherein the pump 8 is configured to move (i.e. pump) water from the water supply 6 via the supply line 7 into the buffer tank 2. Additionally or alternatively, the water supply 6 and buffer tank 2 may be arranged such that water is supplied or moved from the water supply 6 to the buffer tank 2 by gravity only. In this case, a valve may be provided, which is configured to selectively allow or not allow a flow of water from the water supply 6 into the buffer tank 2.

The beverage preparation device 1 may comprise a water connection (not shown). The water connection may be adapted to be connected with a water network, such as with an outlet for mains water. Via the water connection, the buffer tank 2 may be filled with water. The water connection is preferably connected to the supply line 7 so that water can enter via the water connection the supply line 7 and finally into the buffer tank 2. Preferably, the water connection is adapted so that the water supply 6 can be connected with the water connection. As such, water can be supplied from the water supply 6 via the water connection to the supply line 7.

The supply line 7 may comprise a water filter 9 for filtering water passing through the supply line 7 from the water supply 6, or from the water connection, to the buffer tank 2. The water filter 9 may be positioned downstream of the pump 8 with respect to a flow direction (or redirection) from the water supply 6 or pump 8 to the buffer tank 2. The water filter 9 is not limited to a specific water filter as long as the water filter 9 can prevent particles (such as germs or other particles facilitating the formation of germs) from moving into the buffer tank 2. The water filter 9 may comprise at least one of the group consisting of a particle filter, an ultrafiltration device, and nano-filtration device, an active carbon device, and a reverse osmosis device.

The buffer tank 2 may be automatically supplied with water via the supply line 7. For example, the buffer tank 2 comprises a sensor unit, which is adapted for sensing the level of the water or liquid material within the buffer tank 2. When the measured level falls below a predetermined water level, water is supplied via the supply line 7 into the buffer tank 2 at least until the predetermined level is reached; supplying of water via the supply line 7 may then stop. The sensor unit may comprise one or more sensors positioned at defined levels or heights of the buffer tank 2 so that the actual level of the water can be measured within the buffer tank 2. Additionally or alternatively, the buffer tank 2 may be supplied with water via a supply line 7 on demand. As such, a user or consumer of the beverage preparation device 1 may input a user input (e.g. for dispensing a beverage) wherein subsequently the buffer tank 2 is filled with water until a predetermined level or the before-mentioned predetermined level has been reached. The actual level of the buffer tank 2 may be measured by the sensor unit.

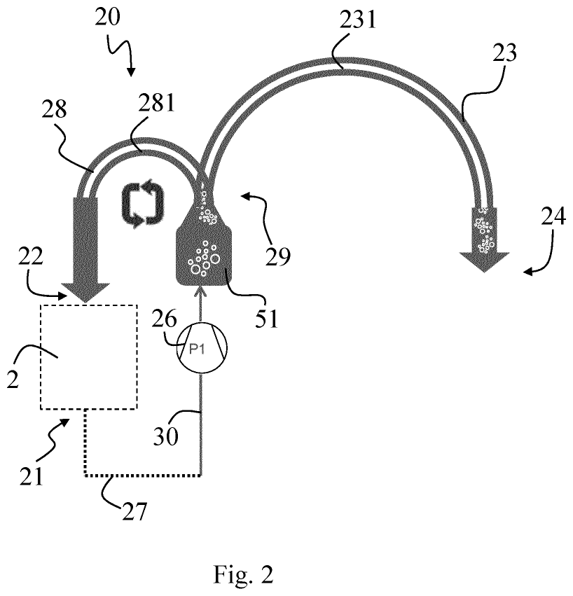

The beverage preparation device 1 further comprises a recirculation line 20, which is configured to allow water circulating out of and back into the buffer tank 2 in order to form a recirculation path together with the buffer tank 2. The recirculation path thus effects a “loop sanitization” and therefore forms a “loop sanitizer”. The recirculation line 20 may comprise a water inlet 21 and a water outlet 22. By way of the water inlet 21 water is drawn from the buffer tank 2, wherein this drawn water can be circulated back into the buffer tank 2 via the water outlet 22. As can be seen in FIGS. 1 and 2, the beverage preparation device further comprises a discharge line 23 for discharging the water from the buffer tank 2 via a discharge outlet 24. The discharge outlet 24 may be arranged such that water flowing through the discharge outlet 24 is discharged out of the beverage preparation device 1, such as in a container 25 (e.g. a cup) positioned downstream of the discharge outlet 24 with respect to a flow from the discharge line 23 to the discharge outlet 24. The discharge outlet 24 may be arranged such that the flow of water exiting the discharge outlet 24 can (e.g. directly) enter the container 25, which is, for example, positioned on a support of the beverage preparation device 1. For example, the discharge outlet 24 is positioned opposite and/or above said support.

The beverage preparation device 1 further comprises a pump 26 (i.e. a main pump) to circulate water selectively along the recirculation path, i.e. at least along the recirculation line 20 and the buffer tank 2, or along the discharge line 23 towards the discharge outlet 24. The recirculation line 20 may comprise an inlet line 27, which may comprise the water inlet 21. The recirculation line 20 may comprise an outlet line 28, which may comprise the water outlet 22. As such, the pump 26 may circulate the water selectively towards the discharge line 23 or towards the outlet line 28 and, thus, along the recirculation path. Preferably, the beverage preparation device 1 comprises a flow direction device for controlling the flow of water circulating selectively along the recirculation path or the discharge line 23 towards the discharge outlet 24. The flow direction device therefore may facilitate that in a first configuration water is flowing substantially only towards the outlet line 28, thus circulating along the recirculation path, and not towards the discharge line 23 and discharge outlet 24. In a second configuration of the flow direction device, water is flowing substantially only or at least partially towards the discharge line 23 and discharge outlet 24, and not or with at least a reduced amount towards the outlet line 28.

In the preferred embodiment shown in the figures, in particular shown in more detail in FIG. 2, the flow direction device comprises a branching section 29. The branching section 29 is arranged in the recirculation line 20 for branching off the discharge line 23. Preferably, the branching section 29 further branches off the outlet line 28 of the recirculation line 20. Dependent on the flow rate of the pump 26, the flow of water can circulate selectively via the branching section 29 and the recirculation path or via the branching section 29 and the discharge line 23 towards the discharge outlet 24. More specifically, this may be effected by the discharge line 23 extending to a higher level (or generally further) than the recirculation line 20, in particular the outlet line 28. As such, water pumped by the pump 26 at a flow rate below a defined threshold value (a low flow rate such as below 100 mL/minute) drains via the recirculation line 20 back into the buffer tank 2, and thus preferably not into the discharge line 23. In other words, the water pumped by the pump 26 has, due to the set flow rate, not enough energy for flowing towards the discharge line 23 and out of the discharge outlet 24. Thereby, substantially all of the water pumped by the pump 26 drains via the recirculation line 20 back into the buffer tank 2. If the pump 26 pumps the water with a flow rate at or above the defined threshold value (e.g. above 1500 mL/minute), the water flows via the discharge line 23 towards and out of the discharge outlet 24. In this case, the water pumped by the pump 26 has enough energy for flowing via the discharge line 23 and towards and out of the discharge outlet 24.

In other words, the branching section 29 is provided downstream a (first) delivery line 30 of the recirculation line 20, wherein the branching section 29 branches the delivery line 30 into the outlet line (second delivery line) 28 and discharge line (third delivery line) 23. If water is delivered by the pump 26 at the flow rate below a defined threshold value, the water is delivered beyond a section 281 of the outlet line 28 (e.g. its highest section) but not beyond a section 231 of the discharge line 23 (e.g. a section being higher than the section 281 of the outlet line 28). Thereby, water is discharged via the outlet 22 of the outlet line 28 into the buffer tank 2 and, thus, the water circulates (continuously) along the recirculation path for sanitization. If the water is delivered by the pump 26 at the flow rate at or above the defined threshold value, the water is at least partially (preferably only) delivered beyond the section 231 of the discharge line 23 to be discharged via the discharge outlet 24. The flow rate at or above the defined threshold value may thus be set when the water is purified and ready to drink.

With such an arrangement it is thus facilitated that only dependent on the energy of the flow of water, which particularly depends on the flow rate, e.g. set by the pump 26 or any other flow rate control device, the (pumped) flow of water can be redirected, i.e. selectively along the recirculation path (in particular the recirculation line 20 and/or the outlet line 28) or the discharge line 23. In other words, the flow (re)direction device constituted by the branching section 29, the outlet line 28 and the discharge line 23 form a passive arrangement (component). That is, the flow direction device forming the passive arrangement is not required to be actively controlled or manipulated in order to redirect the flow as described above.

As mentioned before, the discharge line 23 may, compared to the recirculation line 20 (in particular to the outlet line 28), reach higher with respect to the vertical. Additionally or alternatively, the discharge line 23 may, compared to the recirculation line 20 (in particular to the outlet line 28) reach further with respect to a direction that is (slightly) oblique the horizontal, such as oblique with an angle in the range from 0.5-5°; in other words said direction may extend substantially in the horizontal. This is particularly advantageous in order to remove residual water remaining in the recirculation line 20 and/or discharge line 23, since the residual water can then flow by gravity out of the respective line, e.g. towards the discharge outlet 24 and/or the outlet 22.

The discharge line 23 and the outlet line 28 are not limited to a specific design or arrangement. Preferably, the discharge line 23 extends longer than the outlet line 28. Thus, when seen along the (line or longitudinal) extending direction of the respective line 23, 28, the section 231 may be further distanced from the branching section 29 than the section 281 from the branching section 29. Each of the discharge line 23 and/or outlet line 28 may extend in a straight, angled or arcuate manner. When extending in an angled manner, the section comprising the angle may comprise the section 231, 281, respectively. When extending in an arcuate manner, the section comprising the arch (or bend) may comprise the section 231, 281, respectively. As can be seen in FIGS. 1 and 2, each of the discharge line 23 and outlet line 28 preferably extends in an arcuate manner, such as in the form of a divided circle. As such, the radius of the arcuate extending discharge line 231 may be greater than the radius of the arcuate extending outlet line 28, such as at least 1.5 times or twice greater.

The beverage preparation device 1 may comprise, in addition or as an alternative to the before-mentioned branching with the branching section 29, a two-way valve, and/or a three-way valve. Having the valve may facilitate that the pump 26 is operated with only one flow rate, when redirection of the flow of water in the discharge line 23 or the recirculation path (e.g. the recirculation line 20 or the outlet line 28) is required. As such, the respective redirection to the recirculation path or the discharge line 23 may be effected by the valve only. Hence, the control of the pump 26 can be simplified. When the valve is provided in addition to the pump 26 being operated at different flow rates to selectively circulate the flow of water along the recirculation path or the discharge line 23, the valve may in particular effect that substantially no water circulates along the recirculation path, when the flow of water circulates along the discharge line 23, and/or that substantially no water circulates along the discharge line 23, when the flow of water circulates along the recirculation path.

Adjusting the flow rate of the water is not limited to the adjustment by the pump 26 as a flow rate control device. For example, the flow rate of the water may be also adjusted by any other flow rate control device. For example, the flow rate of the water may be also adjusted by a valve and/or a tab and/or a faucet. The flow rate control device such as the pump 26 is not limited to be positioned in a specific arrangement as long as the flow rate control device can selectively circulate water along the recirculation path or the discharge line 23. As shown in FIG. 1, the flow rate control device, in this case the pump 26, may be arranged in the delivery line 30 and/or upstream of the branching section 29, e.g. with respect to a flow from the inlet 21 to the branching section 29.

The beverage preparation device 1 further comprises a UV lamp 40 arranged for irradiating UV light at the position along the recirculation path to sanitize the water. Sanitizing water with UV light may be also called ultraviolet germicidal irradiation (UVGI). More specifically, the irradiating UV light (short-wavelength ultraviolet, UV-C) kills or inactivates the germs by destroying structures of the germs, such as nucleid acis, leaving the germs unable to produce a disease. In particular, the UV light kills or inactivates germs such as microorganisms by destroying biomolecules such as nucleid acids and disrupting their DNA, leaving them unable to perform vital cellular functions. Consequently, germs in the water can be eliminated or at least significantly reduced, thereby sanitizing and purifying the water. The wavelengths of the irradiated UV light may be short-wavelength UV (UVC; “germicidal UV”) and/or may be in the range from about 200 nm to 300 nm. These wavelengths are strongly absorbed by the germs/nucleic acids, wherein the absorbed energy results in defects of the germs, including, for example, pyrimidine dimers. These dimers can prevent replication or can prevent the expression of necessary proteins, resulting in the death or inactivation of the organism of the germ. The UV lamp 40 may comprise a light source arranged for emitting (irradiating) the UV light. For example, the UV lamp 40 comprises a Mercury based lamp, ultraviolet light-emitting diodes, and/or a pulsed-xenon lamp.

In general, the UV lamp 40 may be arranged at any position suitable for sanitizing the water, which is to be discharged via the discharge outlet 24, by the irradiated UV light. For example, the UV lamp 40 may be arranged to irradiate UV light into the recirculation path, the recirculation line 20 and/or into the buffer tank 2. Being positioned to irradiate UV light into the recirculation line 20, the UV lamp 40 may be, for example, arranged to irradiate UV light into one or more of the inlet line 27, delivery line 30, branching section 29, and/or outlet line 28. The UV lamp 40 may be also arranged to irradiate UV light into the discharge line 23. The UV lamp 40 may be a single UV lamp or may comprise a plurality of UV lamps, wherein each of these UV lamps is arranged to irradiate UV light into a respective one of the lines 20, 27, 30, 28 or the buffer tank 2.

In addition to the filter 9 of the supply line 7 for filtering water passing through the supply line 7 from the water supply 6 to the buffer tank 2, the beverage preparation device 1 may further comprise a second filter 70 along the recirculation path to sanitize the water on the inlet line 27 (as presented on FIG. 1) or on the delivery line 30 as an alternative. In any case the filter 70 is positioned before the UV lamp 40 to apply a filtering to the water and eliminated any particles (such as germs or other particles facilitating the formation of germs) from moving into the recirculation line 20 of the loop sanitizer. The water filter may comprise at least one of the group consisting of a particle filter, an ultrafiltration device, and nano-filtration device, an active carbon device, and a reverse osmosis device.

According to the arrangement of the beverage preparation device 1, water can circulate along the recirculation path extending from the buffer tank 2 via the recirculation line 20 and back to the buffer tank 2. Hence, this makes it possible that a certain amount or batch of water circulates along the recirculation path (in the beverage preparation device 1) and is sanitized by the UV light irradiated by the UV lamp 40 until the amount of germs (viruses, bacteria, etc.) in this amount of water goes below a certain value, i.e. until this amount of water has been properly sanitized. For example, the beverage preparation device 1 is configured to circulate the amount of water along the recirculation path for a time that is dependent on the amount of water stored in the buffer tank, wherein said amount of water is preferably measured by the beverage preparation device 1. The beverage preparation device 1 may also circulate the amount of water along the recirculation path for a fixed time, which fixed time is sufficient to properly sanitize all amounts of water which can circulate along the recirculation path and/or which can be stored in the buffer tank 2. Additionally, the water is cooled in the buffer tank 2 by the cooling unit 3. With the cooling unit 3, it is, therefore, at the same time ensured that the water, circulating along the recirculation path and being sanitized by the UV light, has such a temperature that the germs or microorganisms are prevented from growing, or at least the growth of the germs or microorganisms is limited. In other words, the germs are both killed (or inactivated and, due to the cooling, at the same time prevented from growing. Therefore, a very efficient purification of the water is achieved.

Preferably, the beverage preparation device 1 comprises a heating unit or boiler 45. This heating unit 45 is arranged to transfer heat to the buffer tank 2 in order to sanitize the water within the buffer tank 2. For example, in an idle state of the beverage preparation device 1, the heating unit 45 is activated, thereby transferring heat into the buffer tank 2 for sanitization. As such, it can be ensured that germs—which may remain in the buffer tank 2 and/or which may not be reached by the UV light irradiated by the UV lamp 40 and/or which cannot flow out of the buffer tank 2 due to the water flow along the recirculation path—can be inactivated or destroyed. The heating unit 45 may be arranged to operate only in the idle mode of the beverage preparation device 1 (i.e. when the beverage preparation device 1 is not cooling and/or not ready for dispensing a beverage). In other words, the heating unit 45 may be arranged to be always deactivated when the beverage preparation device 1 is in an operation mode (i.e. when beverage preparation device 1 is cooling and ready for dispensing a beverage, e.g. when the UV lamp 40, the cooling unit 3, and/or the pump 26 are activated). The heating unit 45 may be arranged to melt the ice layer 5. Since germs may accumulate on the ice layer 5, melting the ice layer 5 may further improve the sanitization of the water.

The beverage preparation device 1 may further comprise an in-line carbonation device 50. The in-line carbonation device 50 is adapted for entering carbon dioxide (CO2) into the circulating water. For example, the carbon dioxide may enter into the circulating water in the discharge line 23 and/or the flow direction device. As can be seen in FIG. 1, the carbon dioxide may enter into the circulating water at the branching section 29. For example, an orifice 51 may be arranged to connect the delivery line 30 with the branching section 29. In other words, the orifice 51 may be arranged between the delivery line 30 and the branching section 29. As such, the carbon dioxide from the in-line carbonation device 50 may enter into this orifice 51. The orifice 51 may extend straight and/or may be designed as a chamber, such as a mixing chamber. The chamber may facilitate that the carbon dioxide effectively enters into the circulating water. A carbon dioxide line 52 may be arranged to connect the in-line carbonation device 50 with the circulating water, for example with the recirculation path (e.g. the orifice 51) or discharge line 23 so that the carbon dioxide can enter into the circulating water. In the carbon dioxide line 52, a valve 53 (e.g. an on/off valve) may be arranged to selectively enter carbon dioxide into the circulating water.

In the preferred embodiment shown in FIGS. 1 and 2, the beverage preparation device 1 further comprises a beverage additive section 60 for dispensing additives via the discharge outlet 24. The beverage additive section 60 may add the additives at a position downstream of the branching section 29 with respect to a flow direction from the branching section 29 via the discharge line 23 and to the discharge outlet 24. With respect to this flow direction, the beverage additive section 60 may add the additives at a position upstream or downstream of the discharge outlet 24, or at the discharge outlet 24.

The beverage additive section 60 may be arranged to dispense only additives and/or to add the additives to water so that the additives provided in the water are subsequently dispensed by the discharge outlet 24 and added to or mixed with the water discharged from the discharge line 23. The beverage additive section 60 may add the additives to (purified) water from the buffer tank 2 or recirculation path 20. For example, the beverage preparation device 1 comprises a further (secondary) discharge line 61, which connects the buffer tank 2 or the recirculation line 20 with the discharge outlet 24. As can be seen in FIG. 1, the inlet line 27 of the recirculation line 20 may branch into the delivery line 30 and the secondary discharge line 61. As such, the water flowing in the inlet line 27 flows both in the delivery line 30 and the secondary discharge line 61. One or more valves may be provided to accordingly control the water flowing through the (primary) discharge line 23 and secondary discharge line 61. The one or more valves may be, in particular, adapted to control the flow rate in each of the primary discharge line 23 and secondary discharge line 61, and/or to allow and stop the flow along the secondary discharge line 61.

The beverage additive section 60 may dispense the additives via the discharge outlet 24 automatically or on demand, for example in response to a user input (on a user interface such as a button or touch screen). Dispensing of the additives may be carried out by a dedicated dispensing unit, which is adapted to dispense the required amounts of the additive(s) for the final product. As can be seen in FIG. 1, the beverage additive section 60 may comprise a pump 62 (e.g. an infusion pump), which is adapted to pump water from the buffer tank 2 or recirculation line 20 into the secondary discharge line 61, e.g. at a flow rate of 0.2 L/min. The additives are added to this pumped water for being subsequently dispensed via the discharge outlet 24. The beverage additive section 60 may also comprise a heating unit or boiler 63 in order to heat the pumped water, wherein the additives are, preferably subsequently, added to this heated water. As such, the additives may further develop in the heated water, for example with respect to the function of the additive and/or the taste of the additive, e.g. by effecting a chemical reaction such as extraction or infusion. The heating unit 63 may be arranged downstream of the pump 62 and upstream of a section, where the additives are added, with respect to the flow direction of the pump 62.

The beverage additive section 60 may be adapted to inject air into the additive and/or the water of the secondary discharge line 62, to which the additive is added. For example, the beverage additive section 61 comprises an air pump 64 for said injection of air. The beverage additive section 60 may thus be operable in a first mode and a second mode, wherein in the first mode air injection is carried out/activated, wherein in the second mode air injection is not carried out/deactivated. For moving the beverage additive section 60 between these two modes, the beverage additive section 60 may comprise a valve 65 such as a (two-) way valve. In a first position of the valve 65, the flow of water flowing from the secondary discharge line 61 is flowing to an air injection line 66, in which air is injected into the water, e.g. by means of the air pump 64. The air injected water is then flowing to a section, where the additives are added to the air injected water. In a second position of the valve 65, the flow of water flowing from the secondary discharge line 61 is flowing directly to the section, where the additives are added to the water, which has consequently no air injected therein.

The beverage additive section 60 may comprise an exhaust port 67, which is adapted for exhausting air out of the beverage additive section 60. The exhausted air may be, for example, air that remains in the beverage additive section 60 without having being injected into the water. The exhaust port 67 may be selectively moved between an open (exhaust) position and a closed position, e.g. by way of a (two-) way valve 68.

The additive may be in the form of a liquid or in the form of a liquid, which comprises solid (additive) particles. The additive may be provided in a dedicated container (a cartridge, a capsule, etc.) that may be detachably connected to and/or may be adapted to be removed from the beverage additive section 60. Dependent on the consumer's desire, one and the same device 1 can thus be equipped with different kinds of additives. For example, the beverage preparation device 1 may be adapted to choose among a plurality of additives. The additives may be added to provide infused water. For example, the additives comprise at least one of the group consisting of: flavours, aromas (for example orange, peach, lemon, etc.), minerals, a mineral liquid concentrate, a functional concentrate (such as an additive comprising a vitamin, caffeine or another coffee extract), an edible flavouring concentrate, a tea and/or coffee extract, a fruit juice, a minerals mother solution or combinations thereof. A “functional concentrate” is to be understood as having an effect on the consumer, such as a product that is probiotic, prophylactic, etc. The beverage additive section 60 is preferably adapted to dispense the additives to the water from the buffer tank 2 (e.g. coming from the primary discharge line 23 and/or the secondary discharge line 61) such that the additives designate an amount up to 20%, preferably 10%, preferably 10%, preferably 0.05% to 1%, preferably 0.1% to 0.5% by volume, of the resulting liquid material in the final (beverage) product. In general, the final product may be (pure) water, soda, lemonade, a soup, etc.

The beverage preparation device 1 may further comprise an insulation housing 80 encapsulating (in an isolating manner) the buffer tank 2, the cooling unit 3, the UV lamp 40 and the recirculation line 20. The insulation housing 80 may also encapsulate the pump 26, the flow direction device (in particular the branching section 29), the supply line 7, and the water filter 9; if present, also the pump 8 may be encapsulated by the housing 80. The housing 80 may not encapsulate the water supply 6, the compressor unit 31, the in-line carbonation device 50, the beverage additive section 60, and/or at least a part of the discharge line 23 and discharge outlet 24. That is, one or more of the parts of the beverage preparation device 1 may be provided on an outside with respect to the housing 80. As such, a very compact design of the beverage preparation device 1 is achieved, while at the same time efficient cooling of the water to be dispensed out of the device 1 or housing 80 is effected. The housing 80 may thus form a temperature isolated area.

It should be clear to a skilled person that the embodiment shown in the figures is only a preferred embodiment, but that, however, also other designs of a beverage preparation device 1 can be used. In general, a “line” is to be understood in a broad manner, i.e. any structure adapted for conveying, guiding and/or moving a liquid or fluid. For example, a “line” may be a tube, a pipe, a channel, or a conduit. Further, the buffer tank 2 is not limited for storing an amount of water only. For example, the buffer tank 2, i.e. its tank body, may also be adapted to store an amount of soda, lemonade, soup, etc.; in other words, the buffer tank 2 may be adapted to store a liquid material, which comprises, besides the amount of water, other ingredients, resulting in compositions such as soda, lemonade, soup, etc.

1. Beverage preparation device comprising:
a buffer tank having a tank body for storing an amount of water,
a recirculation line configured to allow water circulating out of and back into the buffer tank to form a recirculation path together with the buffer tank,
a UV lamp arranged for irradiating UV light at a position along the recirculation path to sanitize the water,
a cooling unit for cooling the water within the buffer tank,
a discharge line for discharging the water from the buffer tank via a discharge outlet, and
a pump for selectively circulating water along the recirculation path or the discharge line towards the discharge outlet.

2. Beverage preparation device according to claim 1, wherein the cooling unit is arranged and configured to freeze an amount of water at an inner wall of the tank body.

3. Beverage preparation device according to claim 1, further comprising a water supply being connected with the buffer tank by a supply line for supplying water into the buffer tank, wherein the water supply is a primary water tank.

4. Beverage preparation device according to claim 3, wherein the supply line comprises a water filter for filtering water passing through the supply line from the water supply to the buffer tank, wherein the water filter comprises at least one element selected from the group consisting of a particle filter, an ultrafiltration device, a nano-filtration device, an active carbon device, and a reverse osmosis device.

5. Beverage preparation device according to claim 1, wherein the UV lamp is arranged to irradiate UV light into the recirculation line and/or into the buffer tank.

6. Beverage preparation device according to claim 1, further comprising a filter along the recirculation path on an inlet line or on a delivery line of the recirculation path and positioned before the UV lamp.

7. Beverage preparation device according to claim 1, further comprising a beverage additive section for dispensing additives via the discharge outlet, wherein the beverage additives section is preferably arranged in a secondary discharge line connecting the buffer tank or the recirculation line with the discharge outlet to feed the beverage additives section with the water from the buffer tank,
the additives comprises at least one of additive selected from the group consisting of: flavours, aromas, mineral particles, a mineral liquid concentrate, a vitamin, caffeine or any plant component, a tea and/or coffee extract, a fruit juice, fruit or vegetable particles or pieces, probiotics, prebiotics and combinations thereof, and
the beverage additive section is adapted to dispense the additives to the water from the buffer tank such that the additives designate an amount up to 20% by volume, of the resulting liquid material in the final product.

8. Beverage preparation device according to claim 1, further comprising a flow direction device for controlling the flow of water circulating selectively along the recirculation path or the discharge line towards the discharge outlet.

9. Beverage preparation device according to claim 1, wherein the flow direction device comprises:
a branching section in the recirculation line for branching off the discharge line, wherein the discharge line extends to a higher level than the recirculation line so that water pumped by the pump at a flow rate below a defined threshold value drains via the recirculation line back into the buffer tank, and water pumped by the pump at a flow rate at or above the defined threshold value flows via the discharge line towards and out of the discharge outlet.

10. Beverage preparation device according to claim 1, further comprising an in-line carbonation device for entering CO₂ into the circulating water.

11. Beverage preparation device according to claim 1, further comprising an insulation housing encapsulating the buffer tank, the cooling unit, the UV lamp and the recirculation line.

12. Beverage preparation device according to claim 1, further comprising a heating unit arranged to transfer heat to the buffer tank in order to sanitize the water within the buffer tank.

13. Method for preparing a beverage, comprising the steps of:
filling water into a buffer tank,
circulating the water along a recirculation path extending from the buffer tank via a recirculation line and back to the buffer tank,
cooling the water in the buffer tank by a cooling unit,
sanitizing the cooled and recirculating water by UV light irradiated by a UV lamp arranged at a position along the recirculation path, and
after the water has been sanitized, discharging the sanitized water via a discharge line and discharge outlet.

14. Method according to claim 13, wherein the buffer tank is supplied with water, automatically and/or on demand, via a supply line.

15. Method according to claim 13 or 111, wherein the recirculation line further comprises a filter at a position along the recirculation path and positioned prior to the UV lamp on the recirculation line.

16. Method according to claim 13, wherein the cooling unit freezes part of the water in the buffer tank at the inner wall of its tank body.

17. Method according to claim 13, wherein a branch section is provided in the recirculation line for branching off the discharge line, and the water circulating at a flow rate below a defined threshold value drains via the recirculation line back into the buffer tank, and water circulating at a flow rate at or above the defined threshold value flows via the discharge line towards and out of the discharge outlet.

18. Method according to claim 13, wherein the water to be discharged via the discharge line and discharge outlet is carbonized by in-line carbonation.
